(19) United States
(12) Patent Application Publication
(10) Pub. No.: US 2011/0262811 A1
(43) Pub. Date: Oct. 27, 2011

(54) ELECTRODE FOR NON-AQUEOUS ELECTROLYTE SECONDARY BATTERY AND PRODUCTION METHOD THEREOF, AND NON-AQUEOUS ELECTROLYTE SECONDARY BATTERY

(76) Inventors: Masahiro Kinoshita, Osaka (JP); Tetsuo Nanno, Osaka (JP)

(21) Appl. No.: 13/142,251

(22) PCT Filed: Jul. 6, 2010
(86) PCT No.: PCT/JP2010/004408

§ 371 Date: Jun. 24, 2011

(30) Foreign Application Priority Data
Sep. 18, 2009 (JP) 2009-216500

(51) Int. Cl. H01M 4/131; H01M 4/1391; H01M 4/62

(52) U.S. Cl. 429/217; 429/209; 429/220; 429/221; 429/223; 429/224; 429/225; 429/229; 429/231.6; 429/231.95; 429/231.1; 29/623.1; 29/623.5

(57) ABSTRACT

Provided is a non-aqueous electrolyte secondary battery having excellent input/output characteristics and excellent adherence between its electrode material mixture layer and current collector. Disclosed is an electrode for a non-aqueous electrolyte secondary battery, having a current collector and an electrode material mixture layer attached to a surface of the current collector, in which the electrode material mixture layer includes a metal oxide-containing electrode active material and a binder; the oil absorption capacity of the electrode active material is 25 g or more and 200 g or less, per 100 g of the electrode active material; and when the thickness of the electrode material mixture layer is designated as T, an amount W₁ of the binder in a region 0.1 T thick from the surface side of the electrode material mixture layer, and an amount W₂ of the binder in a region 0.1 T thick from the current collector side of the electrode material mixture layer, satisfy 0.9≦W₁/W₂≦1.1.

### TECHNICAL FIELD

The present invention mainly relates to an electrode comprising a current collector and an electrode material mixture layer attached to a surface of the current collector, and more specifically to improving the electrode material mixture layer.

### BACKGROUND ART

In recent years, electronic devices are becoming portable and cordless at a rapid pace. As the power source for such electronic devices, there is increased demand for secondary batteries which are compact, lightweight, and high in energy density.

Among them, non-aqueous electrolyte secondary batteries, particularly lithium-ion secondary batteries, have high voltage and high energy density. Therefore, they are anticipated as the power source for devices such as the above. A non-aqueous electrolyte secondary battery comprises a positive electrode, a negative electrode, a separator interposed therebetween, and a non-aqueous electrolyte.

An electrode for a non-aqueous electrolyte secondary battery (hereinafter, also simply referred to as electrode) typically comprises a current collector and an electrode material mixture layer attached to a surface of the current collector. The electrode material mixture layer comprises an electrode active material, a binder, and if necessary, an electrically conductive auxiliary. The electrode active material contributes to charge/discharge reactions in the battery. The electrically conductive auxiliary has a function as an electron conduction path which facilitates electron transfer, so as to allow charge/discharge reactions to proceed more smoothly. The binder has a function of binding together the electrode active material, the electrically conductive auxiliary, and the current collector, so as to allow the electrode to maintain its form.

An electrode is formed, for example, in the following manner. First, an electrode active material, a binder, an electrically conductive auxiliary, and a dispersion medium are mixed together, thereby preparing an electrode material mixture paste. The resultant electrode material mixture paste is applied to a surface of a current collector, followed by drying, thereby forming an electrode material mixture layer on the surface of the current collector. Thereafter, rolling is performed, thereby obtaining an electrode for a non-aqueous electrolyte secondary battery.

Additionally, technological developments are gaining momentum, not only for small-sized secondary batteries for consumer use such as the above, but also for large-sized secondary batteries. A large-sized secondary battery is used, for example, for the power source for electrical energy storage, and for the power source for vehicles such as electric vehicles and hybrid electric vehicles (hereinafter, also referred to as HEV). Such power sources are required to have long-term durability and to be safe.

In terms of use and required characteristics, there is a great difference between large-sized non-aqueous electrolyte secondary batteries and small-sized non-aqueous electrolyte secondary batteries for consumer use. For example, non-aqueous electrolyte secondary batteries for HEVs are required to contribute to power assist or power recovery for the engine, instantly and with limited capacity. Thus, such batteries are required to have high-level input/output characteristics.

In order to enable higher input and output for a battery, it is important to reduce internal resistance of the battery as much as possible. Therefore, from the past, improvements and the like are being made on electrode active materials, non-aqueous electrolytes, and electrode material mixtures, from the aspect such as the above. There are also attempts to increase the reactive area of the electrode by making the electrode thinner and longer. Further, also being considered is a reconsideration of current collection configuration of the electrode and a reduction in resistance among structural components.

For example, PTLs 1 and 2 propose improving electrode material mixtures.

PTL 1 proposes a positive electrode including LiFePO₄ and a binder with high molecular weight.

PTL 2 proposes to eliminate during the electrode plate drying process, the temperature difference between the current collector side and the electrode surface side, for uniform binder distribution in the electrode material mixture layer which includes LiCoO₂.

### CITATION LIST

### Patent Literatures

[PTL 1] Japanese Laid-Open Patent Publication No. 2005-302300
[PTL 2] Japanese Laid-Open Patent Publication No. 2001-210317

### SUMMARY OF INVENTION

### Technical Problem

An electrode active material with a high oil absorption capacity is suited for use in a large-sized non-aqueous electrolyte secondary battery, since input/output characteristics are required of such battery, as described above. An active material with a high oil absorption capacity is capable of retaining a non-aqueous electrolyte with ease, and is therefore considered capable of providing excellent input/output characteristics.

However, an electrode active material with a high oil absorption capacity is likely to absorb liquid components such as a dispersion medium included in an electrode material mixture paste. Therefore, if an attempt is made to control the concentration of solid content in an electrode material mixture paste to be a general value (e.g., about 55 wt %), the amount of the dispersion medium therein would become insufficient, thereby causing excessive increase in the viscosity of the electrode active material mixture paste. If the electrode material mixture paste has an excessively high viscosity and is applied to a current collector in a conventional manner, there would presumably be non-uniformity in the thickness of the electrode material mixture layer.

Therefore, in the case of using an electrode active material with a high oil absorption capacity, the concentration of solid content in an electrode material mixture paste is typically controlled to be low, by adding a dispersion medium in relatively large amounts. For example, the above-described non-uniformity in thickness of an electrode material mixture layer can be controlled to a certain extent, by controlling the concentration of solid content in an electrode material mixture paste to be about 40 wt %. However, since the dispersion medium is added in large amounts, it becomes easier for a binder to move around in the electrode material mixture layer during drying and the like. Thus, the binder with low specific gravity is likely to be non-uniformly present at the surface side of the electrode.

A binder is a resistive element without electron conductivity and does not contribute to charge/discharge reactions. Thus, if a binder is not uniformly distributed inside an electrode material mixture layer, and particularly, if it is non-uniformly present at the surface side of an electrode, resistance would increase at the electrode surface and charge/discharge reactions would not proceed smoothly. Also, since the binder would not be sufficient at the current collector side of the electrode material mixture layer, the electrode material mixture layer would likely be separated from the current collector.

A problem such as the above becomes more notable, as the oil absorption capacity of the electrode active material becomes higher. Thus, it was difficult to achieve excellent input/output characteristics, as well as adherence between the electrode material mixture layer and the current collector.

### Solution to Problem

One aspect of the present invention relates to a non-aqueous electrolyte secondary battery comprising a current collector and an electrode material mixture layer attached to a surface of the current collector, wherein the electrode material mixture layer comprises a metal oxide-containing electrode active material and a binder; the oil absorption capacity of the electrode active material is 25 g or more and 200 g or less, per 100 g of the electrode active material; and when the thickness of the electrode material mixture layer is designated as T, an amount W₁ of the binder in a region 0.1 T thick from the surface side of the electrode material mixture layer, and an amount W₂ of the binder in a region 0.1 T thick from the current collector side of the electrode material mixture layer, satisfy 0.9≦W₁/W₂≦1.1.

Another aspect of the present invention relates to a method for producing an electrode for a non-aqueous electrolyte secondary battery, the method comprising the steps of: preparing an electrode material mixture paste which includes as a solid content, a metal oxide-containing electrode active material and a binder, the concentration of the solid content being 65 to 99 wt %; and pressing the electrode material mixture paste on a surface of a current collector to form a film, followed by drying, thereby forming an electrode material mixture layer, wherein the oil absorption capacity of the electrode active material is 25 g or more and 200 g or less, per 100 g of the electrode active material.

Still another aspect of the present invention relates to a non-aqueous electrolyte secondary battery comprising a positive electrode, a negative electrode, a separator therebetween, and a non-aqueous electrolyte, wherein at least one of the positive electrode and the negative electrode is the above-described electrode for a non-aqueous electrolyte secondary battery.

### Advantageous Effects of Invention

According to the present invention, it is possible to provide an electrode for a non-aqueous electrolyte secondary battery, having excellent input/output characteristics as well as excellent adherence between an electrode material mixture layer and a current collector, and to provide a non-aqueous electrolyte secondary battery.

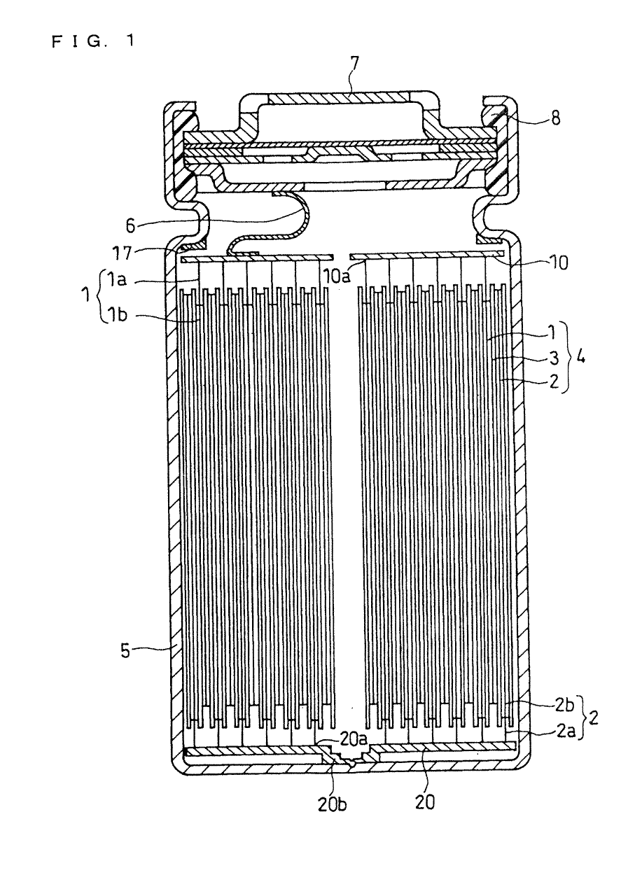

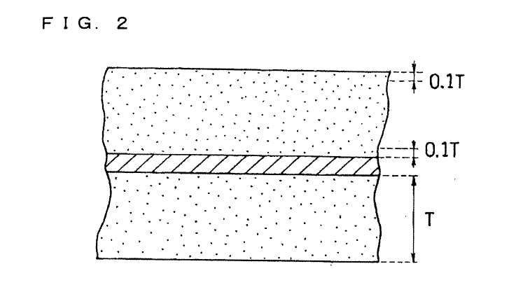

### BRIEF DESCRIPTION OF DRAWINGS

[FIG. 1] A vertical sectional view schematically illustrating the constitution of a cylindrical non-aqueous electrolyte secondary battery according to an embodiment of the present invention.

[FIG. 2] A cross-sectional view schematically illustrating the constitution of an electrode according to an embodiment of the present invention.

### DESCRIPTION OF EMBODIMENTS

An electrode for a non-aqueous electrolyte secondary battery comprises a current collector and an electrode material mixture layer attached to a surface of the current collector. The electrode material mixture layer comprises a metal oxide-containing electrode active material and a binder. The electrode material mixture layer may include a conductive auxiliary, etc. as appropriate.

The oil absorption capacity of the electrode active material is 25 g or more, preferably 50 g or more, and particularly preferably 70 g or more, per 100 g of the electrode active material. If the oil absorption capacity of the electrode active material is lower than 25 g/100 g, the electrode material mixture layer would be unable to sufficiently retain the non-aqueous electrolyte, and input/output characteristics would not be obtained as desired.

The oil absorption capacity of the electrode active material is 200 g or less and more preferably 150 g or less, per 100 g of the electrode active material. If the oil absorption capacity of the electrode active material exceeds 200 g/100 g, a dispersion medium would be absorbed excessively by the electrode active material during preparation of an electrode material mixture paste. As a result, the dispersion medium would be required in large amounts, and the viscosity of the electrode material mixture paste would be insufficient. If the viscosity of the electrode material mixture paste is insufficient, the electrode material mixture would not be dispersed sufficiently, and agglomerates may remain. Thus, the composition of the electrode material mixture layer is likely to become non-uniform.

The electrode active material whose oil absorption capacity is 25 g/100 g or more and 200 g/100 g or less can be synthesized by, for example, spray pyrolysis, freeze-drying, liquid-drying, coprecipitation, hydrothermal synthesis, sol-gel process, or the like. Particularly, porous particles can be easily synthesized by spray pyrolysis, and this method is therefore preferred from the aspect of being capable of easily increasing the oil absorption capacity of the electrode active material. On the other hand, in the case of baking, in which raw materials are mixed and then baked, synthesizing porous particles and increasing the oil absorption capacity of the electrode active material both tend to be difficult, although the above depends on the kind of the electrode active material. For example, LiCoO₂ or the like which is generally obtainable has an oil absorption capacity of less than 25 g/100 g.

The oil absorption capacity of the electrode active material can be measured in the following manner which is based on, for example, the standard ASTM D281-31 test for determining oil absorption capacity.

N-methyl-2-pyrollidone (NMP) is dropped, at a rate of 1 ml/min, to about 20 g of the electrode active material in powder form, while stirring with a spatula or the like. NMP is continued to be dropped, and the amount of NMP added is measured at the point when the electrode active material becomes a mass. The state where the electrode active material becomes a mass can easily be determined, visually. The amount of NMP added per 100 g of the electrode active material, is designated as the oil absorption capacity.

In a preferred embodiment of the present invention, the electrode active material has an olivine crystal structure. This electrode active material (hereinafter, also referred to as olivine-type active material) does not easily release oxygen even under high temperatures, and has an excellent level of thermal safety. Also, the olivine-type active material has excellent lithium-ion intercalation/deintercalation characteristics. The olivine-type active material is particularly useful as the positive electrode active material.

The olivine-type active material has a crystal structure of an orthorhombic crystal belonging to the space group Pnma. An olivine crystal typically has a composition represented by M¹M²XO₄. M¹ is a relatively small cation and M² is a cation larger than M¹.

The olivine-type active material preferred as the active material has, for example, a composition represented by the general formula LiₓMe(PO_{y})_{z}, where 0<x≦2; 3≦y≦4; 0.5<z≦1.5; Me is at least one selected from the group consisting of Na, Mg, Sc, Y, Mn, Fe, Co, Ni, Cu, Zn, Al, Cr, Pb, Sb, and B; and x is a variable that changes depending on charge and discharge of the battery.

However, it is preferable that 20 mol % or more of Me, is Fe. By including 20 mol % or more of Fe, better thermal stability can be obtained and battery cost can be reduced significantly.

The olivine-type active material comprises secondary particles each being a plurality of primary particles which are aggregated or sintered. The volume-based, mean particle size (D₅₀) of the secondary particle of the olivine-type active material is preferably 1 to 50 μm and more preferably 5 to 25 μm. The volume-based, mean particle size (D₅₀) of the primary particle is preferably 0.01 to 1 μm. Also, the BET specific surface area of the olivine-type active material is preferably 5 to 50 m²/g.

The amount of the positive electrode active material relative to the entire positive electrode material mixture layer is preferably 70 to 99 wt % and more preferably 80 to 96 wt %. The positive electrode material mixture layer includes, in addition to the positive electrode active material, the conductive auxiliary, the binder, etc.

The following is an example of a method for producing the olivine-type active material with an oil absorption capacity of 25 g/100 g or more and 200 g/100 g or less.

First, a liquid precursor (solution or dispersion) including a lithium-containing compound, an iron-containing compound, and a phosphorous-containing compound as raw materials is prepared. The resultant liquid precursor is used to produce particles by spray pyrolysis. Specifically, the particles are produced by spraying the liquid precursor in an inert atmosphere and then heating the resultant precursor mist at 400 to 600° C. Thereafter, the produced particles are baked at 400 to 600° C., thereby obtaining an olivine-type active material with an oil absorption capacity of 25 g/100 g or more and 200 g/100 g or less. The oil absorption capacity of the active material can be controlled by, for example, the temperature at which the precursor mist is heated. The baking may be performed for 12 to 24 hours in an inactive atmosphere such as that of N₂, Ar, etc.

Examples of the lithium-containing compound include lithium hydroxide and lithium carbonate. Examples of the iron-containing compound include ferrous chloride tetrahydrate and ferrous oxalate dihydrate. In the alternative, metallic iron may be used as raw material. Examples of the phosphorous-containing compound include phosphoric acid, ammonium dihydrogen phosphate, and diphosphorous pentoxide.

In another preferred embodiment of the present invention, the electrode active material includes a lithium titanium oxide having a spinel crystal structure. The lithium titanium oxide has an excellent level of thermal safety as well as excellent input/output characteristics. The lithium titanium oxide has a composition represented by, for example, the general formula LiₓTi_{y}O_{3-z}, where 0.8≦x≦1.4, 1≦y≦2, and 0≦z≦0.6.

The lithium titanium oxide may include, in place of Ti, a transition element M other than Ti, and that amount is preferably 10 mol % or less of the total of all transition elements. The transition element M is preferably one selected from the group consisting of Na, Mg, Sc, Y, Mn, Fe, Co, Ni, Cu, Zn, Al, Cr. Pb, Sb, and B. The above lithium titanium oxide has a composition represented by, for example, the general formula LiₓTi_{y-w}M_{w}O_{3-z}, where 0.01≦w≦0.2, 0.8≦x≦1.4, 1≦y≦2, and 0≦z≦0.6.

The lithium titanium oxide comprises secondary particles each being a plurality of primary particles which are aggregated or sintered. The volume-based, mean particle size (D₅₀) of the secondary particle of the lithium titanium oxide is preferably 1 to 50 μm and more preferably 5 to 25 μm. The volume-based, mean particle size (D₅₀) of the primary particle is preferably 0.01 to 1 μm. Also, the BET specific surface area of the lithium titanium oxide is preferably 5 to 50 m²/g.

The lithium titanium oxide is particularly useful as the negative electrode active material. This is because the lithium titanium oxide is low in potential relative to lithium metal, and has a higher level of thermal safety compared to a carbon material. Also, titanium oxide, which is a component in the lithium titanium oxide, differs from a carbon material, and in itself, does not have conductivity. Thus, there would be no rapid flow of current, even if an internal short circuit occurs in the battery. Thus, heat generation can be suppressed in the negative electrode.

In the case where the lithium titanium oxide is used as the negative electrode active material, the amount of the negative electrode active material relative to the entire negative electrode material mixture layer is preferably 70 to 96 wt % and more preferably 80 to 96 wt %. The negative electrode material mixture layer, in addition to the negative electrode active material, includes the conductive auxiliary, the binder, etc.

The lithium titanium oxide having a spinel crystal structure and an oil absorption capacity of 25 g/100 g or more and 200 g/100 g or less, can be synthesized, for example, in the following manner.

A liquid precursor (solution or dispersion) including a lithium-containing compound and a titanium-containing compound as raw materials is prepared. The resultant liquid precursor is used to produce particles by spray pyrolysis. Specifically, the particles are produced by spraying the liquid precursor in an oxidative atmosphere and then heating the resulting precursor mist at 500 to 1,000° C. Thereafter, the produced particles are baked at 500 to 1,000° C., thereby obtaining a lithium titanium oxide having a spinel crystal structure and an oil absorption capacity of 25 g/100 g or more and 200 g/100 g or less. The oil absorption capacity of the active material can be controlled by, for example, the temperature at which the precursor mist is heated. Baking may be performed for 12 to 24 hours in an oxidative atmosphere such as that of O₂, air, etc.

Examples of the lithium-containing compound include lithium nitrate, lithium carbonate, and lithium hydroxide. Examples of the titanium-containing compound include alkoxy-titanium (e.g., tetraisopropyl orthotitanate) and titanium oxide.

The electrode for a non-aqueous electrolyte secondary battery of the present invention can be obtained by, for example, a production method comprising the steps of: preparing an electrode material mixture paste which includes as a solid content, a metal oxide-containing electrode active material and a binder, the concentration of the solid content being 65 to 99 wt % and more preferably 70 to 90 wt %; and pressing the electrode material mixture paste on a surface of a current collector to form a film, followed by drying, thereby forming an electrode material mixture layer.

The above method becomes more useful, the smaller the specific gravity of the binder is in comparison with that of the electrode active material. This is because, in the case of using an electrode active material with a high oil absorption capacity, a conventional method would cause the concentration of the solid content in the electrode material mixture paste to become smaller, thereby easily causing a binder with a smaller specific gravity to be non-uniformly present at a surface of the electrode material mixture layer.

Specific examples of the binder include: fluorocarbon resins such as polytetrafluoroethylene, polyvinylidene fluoride, a modified polyvinylidene fluoride, a tetrafluoroethylene-hexafluoropropylene copolymer, and a vinylidene fluoride- hexafluoropropyrene copolymer; rubber particles such as those of styrene-butadiene rubber (SBR); and polyolefin resins such as polyethylene and polypropyrene. The binder may only be one thereof used singly, or may be two or more thereof used in a combination. Particularly, the fluorocarbon resin is suitable as the binder for a positive electrode, and the rubber particles are suitable as the binder for a negative electrode.

Usually, when an electrode active material with a high oil absorption capacity is used, the concentration of solid content in an electrode material mixture paste is made lower. However, in the present invention, the concentration of the solid content in the electrode material mixture paste is made higher than usual. By pressing the above electrode material mixture paste to form a film, the binder can be uniformly distributed in the electrode material mixture layer, even when the active material used has a high oil absorption capacity. Also, since the film is formed by pressing the electrode material mixture paste with a dispersion medium included therein to a certain extent, the thickness of the film does not easily become non-uniform. The amount of the dispersion medium in the electrode material mixture paste can be made less, thereby leading to reductions in both production cost and environmental burden.

With respect to the electrode of the present invention, distribution of the binder in the electrode material mixture layer is made uniform, starting from the current collector side and through to the surface side. Due to the uniform distribution of the binder, the electrode material mixture layer and the current collector can be bound together more strongly, even in the case of using the above electrode active material with a high oil absorption capacity. Also, increasing the concentration of the solid content in the electrode material mixture paste suppresses migration of the binder, thereby enabling suppression of increase in resistance at the electrode surface. Therefore, adherence between the electrode material mixture layer and the current collector, as well as input/output characteristics of the battery, can be achieved with excellent balance.

When the electrode material mixture layer is the positive electrode material mixture layer, the active material density is preferably 1.5 to 2.5 g/cm³ from the aspect of enabling higher input and output. Also, the thickness of the positive electrode material mixture layer is preferably 30 to 100 μm and more preferably 40 to 90 μm.

When the electrode material mixture layer is the negative electrode material mixture layer, the active material density is preferably 1.2 to 1.6 g/cm³ from the aspect of enabling higher input and output. Also, the thickness of the negative electrode material mixture layer is preferably 30 to 100 μm and more preferably 40 to 80 μm.

In the electrode material mixture layer according to the present invention, the binder is uniformly distributed. FIG. 2 is a vertical sectional view schematically illustrating the constitution of an electrode according to an embodiment of the present invention. In the present invention, the binder is determined as uniformly distributed in the electrode material mixture layer of a thickness T, when the amount of the binder in a region 0.1 T thick from the surface side of the electrode material mixture layer and the amount of the binder in a region 0.1 T thick from the current collector side of the electrode material mixture layer, are both the same. Specifically, an amount W₁ of the binder in a region 0.1 T thick from the surface side of the electrode material mixture layer, and an amount W₂ of the binder in a region 0.1 T thick from the current collector side of the electrode material mixture layer, satisfy 0.9≦W₁/W₂≦1.1. Note that the amounts W₁ and W₂ are mean amounts, respectively, in the surface direction of the electrode material mixture layer, and that the electrode material mixture layer may also locally include parts which are either large or small in binder amount.

The state of how the binder is distributed in the electrode material mixture layer can be observed, for example, in the following manner.

With respect to a cross section of the electrode material mixture layer, regions for measurement are arbitrarily selected from the region 0.1 T thick from the surface side and the region 0.1 T thick from the current collector side, respectively, and these selected measurement regions are each divided into 255×255 mini-regions. A method using an electron probe micro-analyzer (EPMA) is employed to obtain intensities of characteristic X-ray spectra of elements which correlate with the amount of the binder in each of the mini-regions. Specifically, the region 0.1 T thick from the surface side and the region 0.1 T thick from the current collector side, of the electrode material mixture layer seen in cross section, are scanned by an electron beam in the surface direction of the electrode; intensities of characteristic X-ray spectra of elements present in each of the mini-regions are obtained; and then the mean intensity is obtained. At this time, it is also possible to measure, in the same manner as above, other measurement regions within the region 0.1 T thick from the surface side and the region 0.1 T thick from the current collector side, to obtain the mean of a plurality of measurement regions. In the present invention, measurements are made for an elemental intensity I₁ which correlates with the amount of the binder in the region 0.1 T thick from the surface side and an elemental intensity I₂ which correlates with the amount of the binder in the region 0.1 T thick from the current collector side, of the electrode material mixture layer seen in cross section. The relation between the elemental intensity and the binder amount can be obtained by creating a calibration curve using a sample with a known binder amount, and then making a comparison.

When the elemental intensities I₁ and I₂ satisfy 0.9≦I₁/I₂≦1.1, a determination can be made that 0.9≦W₁/W₂≦1.1 is satisfied, more specifically, that the binder is uniformly distributed, starting from the current collector side and through to the surface side. It is more preferable that Iₗ/I₂ satisfies 1≦I₁/I₂≦1.06.

Herein, in the method using an EPMA (Electron Probe Micro-Analyzer), a sample (for example, an arbitrary cross section in the case of the present invention) is irradiated with an accelerated electron beam, and characteristic X-ray spectra of elements which correlate with the amount of the binder are detected. This enables detection and identification of the elements present in the mini-regions which are irradiated with the electron beam, as well as analysis of the percentage (concentration) of each of the elements therein.

In EPMA measurement, detection of hydrogen is not possible. In addition, carbon is included in the conductive auxiliary also, thereby making it difficult to identify carbon included in the binder. Thus, it is preferable that element(s) other than the above are detected as being in correlation with the amount of the binder. The element(s) which correlate with the amount of the binder may or may not be component element(s) of the binder. In the case where the binder is a fluorocarbon resin, detection may be performed for fluorine which is a component element thereof.

The binder such as a polyolefin resin and SBR hardly includes element(s) which are other than hydrogen or carbon. Therefore, in the case where EPMA measurement is performed, it is preferable that a detectable element (dyeable element) is separately added or used as a replacement.

In the case where the binder has C═C double bonds, Br may be added, for example, and this Br may be detected as the element which correlates with the amount of the binder. For example, immersing the electrode in an aqueous solution which includes Br enables the Br to be added to the C═C double bonds in the binder, in arbitrary regions of the electrode.

In the case where the binder is a polyolefin resin or the like that does not have C═C double bonds, the element in the binder may be replaced with a dyeable element which may be detected as the element which correlates with the amount of the binder. The dyeable element may be selected as appropriate and without particular limitation, depending on the kind of the binder. For example, in the case where the binder includes polyethylene, any dyeable element, such as Ru, may be used. For example, immersing the electrode in an aqueous solution which includes Ru enables incorporation of the Ru into the polyethylene, in arbitrary regions of the electrode.

The amount of the binder relative to the entire electrode material mixture layer is preferably 3 to 10 wt % and more preferably 3 to 6 wt %, from the aspect of achieving with balance, adherence between the electrode material mixture layer and the current collector as well as discharge capacity.

The electrode material mixture layer may include a conductive auxiliary as appropriate. Examples of the conductive auxiliary include: graphites; carbon blacks such as acetylene black, ketjen black, furnace black, lamp black, and thermal black; carbon fibers; and metallic fibers. The amount of the conductive auxiliary relative to the entire electrode material mixture layer is preferably 1 to 20 wt % and more preferably 3 to 15 wt %.

For the current collector, a long and porous or non-porous conductive substrate is used. For the positive electrode current collector, for example, stainless steel, aluminum, titanium, or the like is used. Also, for the negative electrode current collector, for example, stainless steel, nickel, copper, or the like is used. The thickness of the current collector is not particularly limited, but is preferably 1 to 500 μm and more preferably 5 to 20 μm. By designating the thickness of the current collector to be within the above range, the electrode weight can be reduced, while also sufficiently maintaining the electrode strength. Also, the surface roughness of the current collector is preferably 0.1 μm or less.

There is no particular limitation to the manner in which the electrode material mixture paste is pressed to form a film. For example, the electrode material mixture paste may be disposed on a surface of the current collector, and then pressed with rollers to form a film. By drying thereafter, the electrode material mixture layer can be obtained. The pressing with rollers may be performed a number of times, since such pressing enables the electrode material mixture layer to be easily controlled to have a desired thickness. At this time, it is preferable to provide at one end portion of the positive electrode current collector parallel to the longitudinal direction thereof, an exposed portion, designating it as a current-collecting end surface. Thus, a battery having excellent input/output characteristics can be obtained.

A non-aqueous electrolyte secondary battery comprises a positive electrode, a negative electrode, a separator interposed therebetween, and a non-aqueous electrolyte. At least one of the positive electrode and the negative electrode is the above electrode. At this time, there is no particular limitation to the other electrode, and for example, a conventional positive electrode or negative electrode can be used.

In the following, a cylindrical battery which is an embodiment of the present invention will be described specifically with reference to FIG. 1.

The battery according to the present embodiment has a structure without tabs, and includes an electrode group 4 in cylindrical form, a first current collector plate 10 in disk form, and a second current collector plate 20 in disk form. A first electrode 1 and a second electrode 2 are connected to the first current collector plate 10 and the second current collector plate 20, respectively, with no tabs in between.

The electrode group 4 is assembled in a manner such that the first electrode 1 and the second electrode 2 both in strip form are wound with a separator 3 in strip form therebetween.

The first electrode 1 comprises a first electrode current collector in sheet form and a first electrode material mixture layer 1b formed on both surfaces thereof. At one end portion of the first electrode 1 in the longitudinal direction thereof, an exposed portion 1a of the first electrode current collector is formed. Likewise, the second electrode 2 comprises a second electrode current collector and a second electrode material mixture layer 2b formed on both surfaces thereof. At one end portion of the second electrode 2 in the longitudinal direction thereof, an exposed portion 2a of the second electrode current collector is formed.

The exposed portions of the electrode current collectors, respectively, are portions to be welded to the connecting portions of the current collector plates, respectively. When assembling the electrode group, the exposed portion 1a of the first electrode current collector and the exposed portion 2a of the second electrode current collector are disposed on sides opposing to each other; the first electrode and the second electrode are layered with a separator in between; and then, the resultant is wound. As a result, the exposed portion 1a of the first electrode current collector is disposed at one end surface of the electrode group 4 in columnar form, and the exposed portion 2a of the second electrode current collector is disposed at the other end surface thereof.

From the aspect of facilitating welding, it is preferable that at one end surface of the electrode group 4, the exposed portion 1a of the first electrode current collector protrudes more outwards than the end portion of the second electrode 2 and than the end portion of the separator 3. Likewise, it is preferable that at the other end surface of the electrode group 4, the exposed portion 2a of the second electrode current collector protrudes more outwards than the end portion of the first electrode 1 and than the end portion of the separator 3.

Further, from the aspect of preventing, with certainty, short circuits between the first electrode and the second electrode, it is preferable that the end portion of the separator protrudes more outwards than the end portion of the second electrode 2, at the end surface of the electrode group where the exposed portion 1a of the first electrode current collector is disposed. Likewise, it is preferable that the end portion of the separator 3 protrudes more outwards than the end portion of the first electrode 1, at the end surface of the electrode group where the exposed portion 2a of the second electrode current collector is disposed.

The exposed portion 1a of the first electrode current collector is welded to a connecting portion 10a on one surface of the first current collector plate 10. On the other surface of the first current collector plate 10, an insulating layer 14 is formed. Likewise, the exposed portion 2a of the second electrode current collector is connected to a connecting portion 20a on one surface of the second current collector plate 20. On the other surface of the second current collector plate 20, an insulating layer 24 is formed.

The first current collector plate 10 and the second current collector plate 20 are both made of metal and are in disc form. It is preferable that the current collector plate connected with the positive electrode is made of metal such as aluminum, and the current collector plate connected with the negative electrode is made of metal such as copper and iron. The form of the current collector plates are not particularly limited, but preferably have a form which enables them to entirely cover the end surfaces of the electrode group on which they are abutted. Thus, the form of the current collector plates differs depending on the form of the end surfaces of the electrode group. The thickness of the current collector plate is not particularly limited, but is, for example, 0.5 to 2 mm. One or more through-holes maybe formed on the current collector plates.

For the separator, a microporous membrane, woven fabric, non-woven fabric, or the like having high ion permeability as well as predetermined mechanical strength and insulating properties, is used. Examples of material for the separator preferably include polyolefins such as polypropylene and polyethylene, due to their excellence in durability, having a shutdown function, and being capable of increased level of safety for the non-aqueous electrolyte secondary battery. The thickness of the separator is typically 10 to 300 μm, but is preferably 40 μm or less, more preferably 5 to 30 μm, and particularly preferably 10 to 25 μm. Further, the microporous membrane may be a single-layered membrane made of one material, or a composite membrane or multi-layered membrane made of two or more materials. The porosity of the separator is preferably 30 to 70%. Herein, porosity is the percentage of the pore portion volume relative to the separator volume. A more preferred range for the separator porosity is 35 to 60%.

For the non-aqueous electrolyte, a material in liquid, gelled, or solid form (including a solid polymer electrolyte) can be used.

The non-aqueous electrolyte in liquid form (non-aqueous electrolyte solution) can be obtained by allowing a solute (e.g., lithium salt) to dissolve in a non-aqueous solvent.

For the non-aqueous solvent, it is possible to use, for example, a non-aqueous solvent that is known. This non-aqueous solvent is not particularly limited in kind, but examples thereof include: cyclic carbonate ester, chain carbonate ester, and cyclic carboxylic acid ester. Examples of the cyclic carbonate ester include propylene carbonate (PC) and ethylene carbonate (EC). Examples of the chain carbonate ester include diethyl carbonate (DEC), ethyl methyl carbonate (EMC), and dimethyl carbonate (DMC). Examples of cyclic carboxylic acid ester include γ-butyrolactone (GBL) and γ-valerolactone. For the non-aqueous solvent, one thereof may be used singly, or two or more thereof may be used in a combination.

For the solute, for example, LiClO₄, LiBF₄, LiPF₆, LiAlCl₄, LiSbF₆, LiSCN, LiCF₃SO₃, LiCF₃SO₃, LiCF₃CO₂, Li(CF₃SO₂)₂, LiAsF₆, LiB₁₀Cl₁₀, lithium lower aliphatic carboxylate, LiCl, LiBr, LiI, chloroborane lithium, borates, imide salts, or the like can be used. Examples of the borates include lithium bis(1,2-benzenediolato(2-)-O,O′)borate, lithium bis(2,3-naphthalenediolato(2-)-O,O′)borate, lithium bis(2,2′-biphenyldiolato(2-)-O,O′)borate, and lithium bis(5-fluoro-2-olato-1-benzenesulfonate(2-)-O,O′)borate. Examples of the imide salt include lithium bistrifluoromethanesulfonyl imide (LiN(CF₃SO₂)₂), lithium trifluoromethanesulfonyl nonafluorobutanesulfonyl imide (LiN(CF₃SO₂) (C₄F₉SO₂)), and lithium bispentafluoroethanesulfonyl imide (LiN(C₂F₅SO₂)₂). For the solute, one thereof may be used singly, or two or more thereof may be used in a combination.

Additionally, it is preferable for the non-aqueous electrolyte to include a cyclic carbonate ester having at least one unsaturated carbon-carbon bond. This is because the non-aqueous electrolyte would then decompose on the negative electrode to form a film with high lithium-ion conductivity, thereby enabling increase in charge/discharge efficiency. Examples of the cyclic carbonate ester having at least one unsaturated carbon-carbon bond include vinylene carbonate (VC), 3-methylvinylene carbonate, 3,4-dimethylvinylene carbonate, 3-ethylvinylene carbonate, 3,4-diethylvinylene carbonate, 3-propylvinylene carbonate, 3,4-dipropylvinylene carbonate, 3-phenylvinylene carbonate, 3,4-diphenylvinylene carbonate, vinyl ethylene carbonate (VEC), and divinyl ethylene carbonate. These may be used singly or in a combination of two or more. Preferred among the above is at least one selected from the group consisting of vinylene carbonate, vinyl ethylene carbonate, and divinyl ethylene carbonate. Note that in the above compounds, a part of hydrogen atoms can be replaced with fluorine atoms. It is preferable that the dissolved amount relative to the non-aqueous solvent in the electrolyte is within the range of 0.5 to 2 mol/L.

Further, the non-aqueous electrolyte may decompose on the electrode during overcharge, thereby forming a film thereon, and a known benzene derivative capable of inactivating batteries may be included in the non-aqueous electrolyte. The benzene derivative preferably has a phenyl group and a cyclic compound group adjacent to the phenyl group. Preferable as the cyclic compound group is a phenyl group, a cyclic ether group, a cyclic ester group, a cycloalkyl group, a phenoxy group, or the like. Specific examples of the benzene derivative include cyclohexyl benzene, biphenyl, and diphenyl ether. These may be used singly or in a combination of two or more. Note that the content of the benzene derivative is preferably 10 vol % of the total of the non-aqueous solvent, or less.

Additionally, the non-aqueous electrolyte in gelled form includes the above non-aqueous electrolyte and a polymer material capable of retaining a non-aqueous electrolyte. For the polymer material, for example, polyvinylidene fluoride, polyacrylonitrile, polyethylene oxide, polyvinyl chloride, polyacrylate, vinylidene fluoride-hexafluoropropylene copolymer, or the like can be suitably used.

In the following, the present invention will be described with reference to Examples and Comparative Examples. Note that the present invention is not limited to these Examples and Comparative Examples.

### EXAMPLES

### Example 1

### (i) Synthesis of Positive Electrode Active Material

A positive electrode active material was synthesized by spray pyrolysis. Lithium hydroxide monohydrate, ferrous chloride tetrahydrate, and phosphoric acid, as primary raw materials, were dissolved at a 1:1:1 molar ratio in distilled water, thereby preparing a liquid precursor. The liquid precursor was atomized in air at 1 atmosphere pressure, followed by heating the precursor in mist form at 500° C., thereby producing particles. Thereafter, the produced particles were baked at 600° C. for 24 hours, thereby obtaining a positive electrode active material A (LiFePO₄). Note that the particles were baked in an Ar atmosphere.

The oil absorption capacity of the resultant positive electrode active material A was obtained in the following manner.

N-methyl-2-pyrollidone (NMP) was dropped at a rate of 1 ml/min into 20 g of the positive electrode active material A, while stirring with a spatula. The amount of NMP added was measured at the point when the positive electrode active material became a mass, and the oil absorption capacity per 100 g of the positive electrode active material A was obtained. The oil absorption capacity of the positive electrode active material A was 129.2 g per 100 g of the active material.

The volume-based, mean particle size of secondary particles of the positive electrode active material A was 15 μm. The BET specific surface area of the positive electrode active material A was 12.5 m²/g.

### (ii) Production of Positive Electrode

A positive electrode material mixture paste with a 75 wt % solid content was prepared by mixing 90 parts by weight of the positive electrode active material A; 5 parts by weight of acetylene black as a conductive auxiliary; 5 parts by weight of polyvinylidene fluoride (PVdF) as a binder; and a proper amount of N-methyl-2-pyrrolidone (NMP) as a dispersion medium.

A proper amount of the positive electrode material mixture paste was disposed on one surface of a 15 μm-thick aluminum foil as a current collector, with use of rollers with a gap therebetween set to 50 μm. Thereafter, with the rollers, the positive electrode material mixture paste was pressed until reaching a predetermined thickness, and a film was formed with a dispersion medium included therein. Due to the hardness of the positive electrode material mixture paste, the thickness of the film was greater than the gap between the rollers. Thereafter, the resultant was dried at 100° C., thereby forming a positive electrode material mixture layer. A similar process was also performed on the other surface of the current collector, thereby forming the positive electrode material mixture layer on both surfaces of the positive electrode current collector. The thickness of the positive electrode (the positive electrode current collector and the positive electrode material mixture layers, in total) was 120 μm. At this time, provided along one end portion of the positive electrode current collector parallel to the longitudinal direction thereof, was an exposed portion without the positive electrode material mixture layer formed thereon. The exposed portion was disposed so as to be at one end surface of the electrode group when assembled. The active material density of the positive electrode material mixture layer, obtained from the weight and thickness of the positive electrode, was 2.0 g/cm³. The thickness of the positive electrode material mixture layer was measured at ten arbitrary points, but non-uniformity in thickness was not observed.

(iii) Production of Negative Electrode

A negative electrode material mixture paste with a 75 wt % solid content was prepared by mixing 95 parts by weight of artificial graphite powder as a negative electrode active material; 5 parts by weight of PVdF as a binder; and a proper amount of NMP as a dispersion medium. The resultant negative electrode material mixture paste was applied to both surfaces of a negative electrode current collector made of a 10 μm-thick copper foil, followed by drying. Thereafter, rolling was performed, thereby producing a negative electrode. The thickness of the negative electrode (the negative electrode current collector and the negative electrode material mixture layers, in total) was 110 μm. At this time, provided along one end portion of the negative electrode current collector parallel to the longitudinal direction thereof, was an exposed portion without the negative electrode material mixture layer formed thereon. The exposed portion was disposed so as to be at the other end surface of the electrode group when assembled.

### (iv) Preparation of Non-Aqueous Electrolyte

One wt % of vinylene carbonate was added to a mixed solvent of ethylene carbonate and ethyl methyl carbonate mixed at a 1:3 volume-to-volume ratio. Thereafter, LiPFi was dissolved at a concentration of 1.0 mol/L in the mixed solvent, thereby preparing a non-aqueous electrolyte.

### (v) Fabrication of Battery

A current collector plate (thickness: 0.3 mm) made of aluminum was welded to the exposed portion of the positive electrode current collector. Also, a current collector plate (thickness: 0.3 mm) made of nickel was welded to the exposed portion of the negative electrode current collector. Thereafter, the electrode group was inserted into a cylindrical battery case 18 mm in diameter and 65 mm in height. Next, 5.2 ml of the non-aqueous electrolyte was injected into the battery case, thereby fabricating a battery A. The design capacity of the battery was 1,200 mAh.

### Comparative Example 1

A positive electrode active material B (LiFePO₄) was obtained by mixing lithium hydroxide monohydrate, ferrous oxalate dihydrate, and ammonium dihydrogen phosphate, as primary raw materials, at a 1:1:1 molar ratio, followed by baking at 600° C. for 24 hours. Note that the baking was performed in an Ar atmosphere.

The oil absorption capacity of the resultant positive electrode active material B was obtained in the same manner as in Example 1, resulting in 23.3 g/100 g. The volume-based, mean particle size D₅₀ of the positive electrode active material B was 5.5 μm. The BET specific surface area of the positive electrode active material B was 6.1 m²/g.

A battery B was fabricated in the same manner as in Example 1, except for using the positive electrode active material B.

### Example 2

### (i) Production of Positive Electrode

A positive electrode material mixture paste with a 55 wt % solid content was prepared by mixing 90 parts by weight of lithium cobaltate (oil absorption capacity: 11.2 g/100 g) as a positive electrode active material; 5 parts by weight of acetylene black as a conductive auxiliary; 5 parts by weight of PVdF as a binder; and a proper amount of NMP as a dispersion medium. The positive electrode material mixture paste was applied to both surfaces of a positive electrode current collector made of a 15 μm-thick aluminum foil, followed by drying. Thereafter, rolling was performed, thereby producing a positive electrode. The thickness of the positive electrode (the positive electrode current collector and the positive electrode material mixture layers, in total) was 120 μm. At this time, in the same manner as in Example 1, provided along one end portion of the positive electrode current collector parallel to the longitudinal direction thereof, was an exposed portion. The exposed portion was disposed so as to be at one end surface of the electrode group when assembled.

### (ii) Production of Negative Electrode Active Material

A negative electrode active material was synthesized by spray pyrolysis. Lithium nitrate and tetraisopropyl orthotitanate, as primary raw materials, were dissolved at a 4:5 weight-to-weight ratio in distilled water, thereby preparing a liquid precursor. The liquid precursor was atomized in air at 1 atmosphere pressure, followed by heating the precursor in mist format 800° C., thereby producing particles. Thereafter, the produced particles were baked at 850° C. for 12 hours, thereby obtaining a negative electrode active material C (Li₄Ti₅O₁₂). Note that the particles were baked in air. The oil absorption capacity of the resultant negative electrode active material C was obtained in the same manner as in Example 1, resulting in 96.6 g/100 g.

The volume-based, mean particle size D₅₀ of secondary particles of the negative electrode active material C was 18 μm. The BET specific surface area of the negative electrode active material C was 18.1 m²/g.

A negative electrode material mixture paste with a 75 wt % solid content was prepared by mixing 90 parts by weight of the negative electrode active material C; 5 parts by weight of acetylene black as a conductive auxiliary; 5 parts by weight of PVdF as a binder; and a proper amount of NMP as a dispersion medium.

A proper amount of the negative electrode material mixture paste was disposed on one surface of a 10 μm-thick copper foil as a current collector, with use of rollers with a gap therebetween set to 40 μm. Thereafter, with the rollers, the negative electrode material mixture paste was pressed until reaching a predetermined thickness, and a film was formed with a dispersion medium included therein. Due to the hardness of the negative electrode material mixture paste, the thickness of the film was greater than the gap between the rollers. Thereafter, the resultant was dried at 100° C., thereby forming a negative electrode material mixture layer. A similar process was also performed on the other surface of the current collector, thereby forming the negative electrode material mixture layer on both surfaces of the negative electrode current collector. The thickness of the negative electrode (the negative electrode current collector and the negative electrode material mixture layers, in total) was 110 μm. At this time, in the same manner as in Example 1, provided along one end portion of the negative electrode current collector parallel to the longitudinal direction thereof, was an exposed portion. The exposed portion was disposed so as to be at the other end surface of the electrode group when assembled. The active material density of the negative electrode material mixture layer, obtained from the weight and thickness of the negative electrode, was 1.5 g/cm³.

A battery C was fabricated in the same manner as in Example 1, except for using the above positive and negative electrodes.

### Comparative Example 2

Titanium oxide and lithium carbonate were mixed at a 5:4 molar ratio, followed by baking at 850° C., thereby obtaining a negative electrode active material D (Li₄Ti₅O₁₂).

The oil absorption capacity of the resultant negative electrode active material D was obtained in the same manner as in Example 1, resulting in 14.7 g/100 g. The volume-based, mean particle size D₅₀ of secondary particles of the negative electrode active material D was 4.9 μm. The BET specific surface area of the negative electrode active material D was 5.4 m²/g.

A battery D was fabricated in the same manner as in Example 2, except for using the negative electrode active material D.

### Comparative Example 3

A positive electrode material mixture paste with a 40 wt % solid content was prepared by mixing 90 parts by weight of the positive electrode active material A; 5 parts by weight of acetylene black; 5 parts by weight of PVdF; and a proper amount of NMP.

The resultant positive electrode material mixture paste was applied by doctor blading, to both surfaces of a current collector similar to the one in Example 1, followed by drying. Thereafter, rolling was performed with rollers, thereby producing a positive electrode. The thickness of the positive electrode (the positive electrode current collector and the positive electrode material mixture layers, in total) was 120 μm.

A battery E was fabricated in the same manner as in Example 1, except for using the resultant positive electrode.

### Comparative Example 4

A battery F was fabricated in the same manner as in Comparative Example 3, except for using the positive electrode active material B of Comparative Example 1.

### Comparative Example 5

A negative electrode material mixture paste with a 40 wt % solid content was prepared by mixing 90 parts by weight of the negative electrode active material C; 5 parts by weight of acetylene black; 5 parts by weight of PVdF; and a proper amount of NMP.

The resultant negative electrode material mixture paste was applied to a current collector similar to the one in Example 2, followed by drying. Thereafter, rolling was performed with rollers, thereby producing a negative electrode. The thickness of the negative electrode (the negative electrode current collector and the negative electrode material mixture layers, in total) was 110 μm.

A battery G was fabricated in the same manner as in Example 2, except for using the resultant negative electrode.

### Comparative Example 6

A battery H was fabricated in the same manner as in Comparative Example 5, except for using the negative electrode active material D of Comparative Example 2.

### Example 3

A positive electrode active material I was obtained in the same manner as in Example 1, except for producing particles by heating a precursor mist at 570° C. The oil absorption capacity of the resultant positive electrode active material I was obtained in the same manner as in Example 1, resulting in 26.5 g/100 g. Except for using this positive electrode active material I, a battery I was fabricated in the same manner as in Example 1.

### Example 4

A positive electrode active material J was obtained in the same manner as in Example 1, except for producing particles by heating a precursor mist at 550° C. The oil absorption capacity of the resultant positive electrode active material J was obtained in the same manner as in Example 1, resulting in 50.5 g/100 g. Except for using this positive electrode active material J, a battery J was fabricated in the same manner as in Example 1.

### Example 5

A positive electrode active material K was obtained in the same manner as in Example 1, except for producing particles by heating a precursor mist at 530° C. The oil absorption capacity of the resultant positive electrode active material K was obtained in the same manner as in Example 1, resulting in 71.2 g/100g. Except for using this positive electrode active material K, a battery K was fabricated in the same manner as in Example 1.

### Example 6

A positive electrode active material L was obtained in the same manner as in Example 1, except for producing particles by heating a precursor mist at 470° C. The oil absorption capacity of the resultant positive electrode active material L was obtained in the same manner as in Example 1, resulting in 161.7 g/100 g. Except for using this positive electrode active material L, a battery L was fabricated in the same manner as in Example 1.

### Comparative Example 7

A positive electrode active material M was obtained in the same manner as in Example 1, except for producing particles by heating a precursor mist at 400° C. The oil absorption capacity of the resultant positive electrode active material M was obtained in the same manner as in Example 1, resulting in 219 g/100 g. Except for using this positive electrode active material M, a battery M was fabricated in the same manner as in Example 1.

### Example 7

A negative electrode active material N was obtained in the same manner as in Example 2, except for producing particles by heating a precursor mist at 890° C. The oil absorption capacity of the resultant negative electrode active material N was obtained in the same manner as in Example 2, resulting in 26.4 g/100 g. Except for using this negative electrode active material N, a battery N was fabricated in the same manner as in Example 1.

### Example 8

A negative electrode active material O was obtained in the same manner as in Example 2, except for producing particles by heating a precursor mist at 850° C. The oil absorption capacity of the resultant negative electrode active material O was obtained in the same manner as in Example 2, resulting in 54.1 g/100 g. Except for using this negative electrode active material O, a battery O was fabricated in the same manner as in Example 2.

### Example 9

A negative electrode active material P was obtained in the same manner as in Example 2, except for producing particles by heating a precursor mist at 820° C. The oil absorption capacity of the resultant negative electrode active material P was obtained in the same manner as in Example 2, resulting in 76.8 g/100 g. Except for using this negative electrode active material P, a battery P was fabricated in the same manner as in Example 2.

### Example 10

A negative electrode active material Q was obtained in the same manner as in Example 2, except for producing particles by heating a precursor mist at 680° C. The oil absorption capacity of the resultant negative electrode active material Q was obtained in the same manner as in Example 2, resulting in 156.2 g/100 g. Except for using this negative electrode active material Q, a battery Q was fabricated in the same manner as in Example 2.

### Comparative Example 8

A negative electrode active material R was obtained in the same manner as in Example 2, except for producing particles by heating a precursor mist at 600° C. The oil absorption capacity of the resultant negative electrode active material R was obtained in the same manner as in Example 2, resulting in 215.5 g/100 g. Except for using this negative electrode active material R, a battery R was fabricated in the same manner as in Example 2.

Table 1 shows the respective constitutions of batteries A to R obtained as above. Batteries A to R were evaluated in terms of binder distribution in the electrode material mixture layer, and input/output characteristics of the battery.

TABLE 1

| | | | | Temperature | | |
|---|---|---|---|---|---|---|
| | | | | at which | | Concentration |
| | | | | particles | Baking | of |
| | | Positive | Negative | produced | temperature | solid |
| | Battery | electrode | electrode | (° C.) | (° C.) | content |
| Ex. 1 | A | LiFePO₄ | artificial | 500 | 600 | 75 |
| | | (spraying) | graphite | | | |
| Comp. | B | LiFePO₄ | artificial | — | 600 | 75 |
| Ex. 1 | | (solid- | graphite | | | |
| | | phase | | | | |
| | | synthesis) | | | | |
| Ex. 2 | C | LiCoO₂ | Li₄Ti₅O₁₂ | 800 | 850 | 75 |
| | | | (spraying) | | | |
| Comp. | D | LiCoO₂ | Li₄Ti₅O₁₂ | — | 850 | 75 |
| Ex. 2 | | | (solid- | | | |
| | | | phase | | | |
| | | | synthesis) | | | |
| Comp. | E | LiFePO₄ | artificial | 500 | 600 | 40 |
| Ex. 3 | | (spraying) | graphite | | | |
| Comp. | F | LiFePO₄ | artificial | — | 600 | 40 |
| Ex. 4 | | (solid- | graphite | | | |
| | | phase | | | | |
| | | synthesis) | | | | |
| Comp. | G | LiCoO₂ | Li₄Ti₅O₁₂ | 800 | 850 | 40 |
| Ex. 5 | | | (spraying) | | | |
| Comp. | H | LiCoO₂ | Li₄Ti₅O₁₂ | — | 850 | 40 |
| Ex. 6 | | | (solid- | | | |
| | | | phase | | | |
| | | | synthesis) | | | |
| Ex. 3 | I | LiFePO₄ | artificial | 570 | 600 | 75 |
| | | (spraying) | graphite | | | |
| Ex. 4 | J | LiFePO₄ | artificial | 550 | 600 | 75 |
| | | (spraying) | graphite | | | |
| Ex. 5 | K | LiFePO₄ | artificial | 530 | 600 | 75 |
| | | (spraying) | graphite | | | |
| Ex. 6 | L | LiFePO₄ | artificial | 470 | 600 | 75 |
| | | (spraying) | graphite | | | |
| Comp. | M | LiFePO₄ | artificial | 400 | 600 | 75 |
| Ex. 7 | | (spraying) | graphite | | | |
| Ex. 7 | N | LiCoO₂ | Li₄Ti₅O₁₂ | 890 | 850 | 75 |
| | | | (spraying) | | | |
| Ex. 8 | O | LiCoO₂ | Li₄Ti₅O₁₂ | 850 | 850 | 75 |
| | | | (spraying) | | | |
| Ex. 9 | P | LiCoO₂ | Li₄Ti₅O₁₂ | 820 | 850 | 75 |
| | | | (spraying) | | | |
| Ex. 10 | Q | LiCoO₂ | Li₄Ti₅O₁₂ | 680 | 850 | 75 |
| | | | (spraying) | | | |
| Comp. | R | LiCoO₂ | Li₄Ti₅O₁₂ | 600 | 850 | 75 |
| Ex. 8 | | | (spraying) | | | |

### (Analysis of Binder Distribution in Electrode Material Mixture Layer)

With respect to the produced electrodes, each was cut to be 3 cm square and was then covered with epoxy resin (available from Nagase ChemteX Corporation) for hardening. Thereafter, cross-section polishing (roughness: #2000) of the hardened matter was performed with a polisher, thereby allowing a cross section of the electrode to be exposed. Thereafter, binder distribution was measured with a wavelength-dispersive EPMA (JXA-8900 available from JEOL Ltd.). The accelerating voltage of the electron beam was 5 kV. Target range for the measurement was identified in an SEM image, the range visible at 150×SEM magnification being designated as the area to be measured, and fluorine atoms composing the PVdF binder were quantitatively analyzed, the fluorine being seen as the element which correlates with the binder amount.

With respect to a cross section of the electrode material mixture layer, regions for measurement were arbitrarily selected from a region 0.1 T thick from the surface side and a region 0.1 T thick from the current collector side, respectively, and the selected measurement regions were each divided into 255×255 mini-regions. Thereafter, intensities of characteristic X-ray spectra of fluorine atoms in each of the mini-regions were obtained, and then the mean intensity was obtained.

With respect to the region 0.1 T thick from the surface side of the electrode material mixture layer as illustrated in FIG. 2, a region for measurement 100 μm in length was selected and the mean of spectral intensities in mini-regions included in the measurement region was obtained, resulting in designating the mean of the spectral intensities at ten different points in the measurement region as a digital characteristic X-ray intensity I₁ emitted by fluorine from the surface side of the electrode material mixture layer. Likewise, with respect to the region 0.1 T thick from the current collector side of the electrode material mixture layer, a region for measurement 100 μm in length was selected and the mean of spectral intensities in mini-regions included in the measurement region was obtained, resulting in designating the mean of the spectral intensities at ten different points in the measurement region as a digital characteristic X-ray intensity I emitted by fluorine from the current collector side of the electrode material mixture layer.

The binder was determined as uniformly distributed, when I₁/I₂ satisfied 0.9≦I₁/I₂≦1.1.

### (Input/Output Characteristics)

In a 20° C. atmosphere, each battery was subjected to charge/discharge cycle repeated three times, each cycle consisting of charge at a 0.2 C charge current until 4.2 V and discharge at a 0.2 C discharge current until 2.5 V; followed by charge at a 0.2 C charge current until 4.2 V and discharge at a 5 C discharge current until 2.5 V (Test 1)

Additionally, in a 20° C. atmosphere, each battery was subjected to charge/discharge cycle repeated three times, each cycle consisting of charge at a 0.2 C charge current until 4.2 V and discharge at a 0.2 C discharge current until 2.5 V; followed by charge at a 5 C charge current until 4.2 V and discharge at a 0.2 C discharge current until 2.5 V (Test 2).

The discharge capacities at the 3^{rd} and 4^{th} cycles, respectively, in Test 1, were designated as D_{0.2} and D₅, respectively. The charge capacities at the 3^{rd} and 4^{th} cycles, respectively, in Test 2, were designated as C_{0.2} and C₅, respectively. For each battery, C₅/C_{0.2} and D₅/D_{0.2} were obtained and input/output characteristics were evaluated.

C5/C_{0.2} represents a rate of charge capacity at 5 C to that at 0.2 C. D₅/D_{0.2} represents a rate of discharge capacity at 5 C to that at 0.2 C. It can be said that the higher these values, the better the charge/discharge characteristics at times of high-rate operations, and that the battery has excellent input/output characteristics.

TABLE 2

| | | Oil | | Input | Output |
|---|---|---|---|---|---|
| | | absorption | | characteristics | characteristics |
| | | capacity | | C₅/C_{0.2} | D₅/D_{0.2} |
| | Battery | (g/100 g) | I₁/I₂ | (%) | (%) |
| Ex. 1 | A | 129.2 | 1.03 | 88.3 | 89.1 |
| Comp. | B | 23.3 | 1.01 | 83.4 | 82.2 |
| Ex. 1 | | | | | |
| Ex. 2 | C | 96.6 | 1.06 | 87.6 | 89.9 |
| Comp. | D | 14.7 | 1.01 | 83.1 | 82.6 |
| Ex. 2 | | | | | |
| Comp. | E | 129.2 | 2.21 | 86.9 | 86.6 |
| Ex. 3 | | | | | |
| Comp. | F | 23.3 | 1.25 | 81.5 | 82.3 |
| Ex. 4 | | | | | |
| Comp. | G | 96.6 | 1.72 | 86.8 | 88 |
| Ex. 5 | | | | | |
| Comp. | H | 14.7 | 1.43 | 83 | 81.9 |
| Ex. 6 | | | | | |
| Ex. 3 | I | 26.5 | 0.99 | 85.3 | 84.1 |
| Ex. 4 | J | 50.5 | 1.01 | 86.6 | 87.7 |
| Ex. 5 | K | 71.2 | 1.02 | 87.5 | 86.9 |
| Ex. 6 | L | 161.7 | 1.08 | 87.6 | 87 |
| Comp. | M | 219 | 1.17 | 83.4 | 83.3 |
| Ex. 7 | | | | | |
| Ex. 7 | N | 26.4 | 1.02 | 85.6 | 85.5 |
| Ex. 8 | O | 54.1 | 1.06 | 86.4 | 86.7 |
| Ex. 9 | P | 76.8 | 1.07 | 86.8 | 86.5 |
| Ex. 10 | Q | 156.2 | 1.09 | 86.6 | 85.8 |
| Comp. | R | 215.5 | 1.14 | 84.1 | 84.1 |
| Ex. 8 | | | | | |

In Tables 1 and 2, the oil absorption capacity of the positive electrode active material is shown for batteries A, B, E, F, and I to M, and the oil absorption capacity of the negative electrode active material is shown for batteries C, D, G, H, and N to R.

As shown in Table 2, batteries A and I to L whose respective oil absorption capacities of the positive electrode active material were 25 g/100 g or more and 200 g/100 g or less, exhibited better input/output characteristics compared to battery B whose oil absorption capacity was 23.3 g/100 g and to battery M whose oil absorption capacity was 219 g/100 g.

With respect to batteries A and E, whose respective oil absorption capacities of the positive electrode active material used were 129.2 g/100 g, battery A including a positive electrode material mixture paste with a 75% solid content had a more uniform binder distribution and exhibited better input/output characteristics compared to battery E including the same with a 40% solid content. The amount of the dispersion medium was less in battery A than in battery E. The phenomenon of binder migration during the drying process was suppressed as a result, and it is therefore believed that resistance was reduced at the electrode surface, causing input/output characteristics to improve.

Also, with respect to batteries B and F, whose respective oil absorption capacities of the positive electrode active material used were 23.3 g/100 g, they exhibited tendencies similar to those of the above batteries A and E, but the difference therebetween was smaller than the difference between batteries A and E. It can be said that, this shows that increasing the concentration of the solid content in the paste proves particularly effective, when the positive electrode active material used has a high oil absorption capacity.

As with the case of the above positive electrode, batteries C and N to Q whose respective oil absorption capacities of the negative electrode active material were 25 g/100 g or more and 200 g/100 g or less, exhibited better input/output characteristics, compared to battery D whose oil absorption capacity was 14.7 g/100 g and to battery R whose oil absorption capacity was 215.5 g/100 g.

With respect to the concentration of the solid content in the negative electrode material mixture paste, batteries C, D, G, and H exhibited tendencies similar to those of the above batteries A, B, E, and F. Thus, it became evident that the present invention is effective in both the positive and negative electrodes.

### INDUSTRIAL APPLICABILITY

The non-aqueous electrolyte secondary battery in accordance with the present invention is extremely useful as the respective power sources for hybrid vehicles and electric vehicles which require high input/output characteristics.

### REFERENCE SIGNS LIST

1 first electrode

1a exposed portion of first electrode current collector

1b first electrode material mixture layer

2 second electrode

2a exposed portion of second electrode current collector

2b second electrode material mixture layer

3 separator

4 electrode group

5 battery case

6 lead

7 sealing plate

8 gasket

10 first current collector plate

10a, 20a connecting portion

10b through-hole

14, 24 insulating layer

17 insulating member

20 second current collector plate

20b center welding portion

1. An electrode for a non-aqueous electrolyte secondary battery, comprising a current collector and an electrode material mixture layer attached to a surface of said current collector,
wherein said electrode material mixture layer comprises a metal oxide-containing electrode active material and a binder,
the oil absorption capacity of said electrode active material is 25 g or more and 200 g or less, per 100 g of said electrode active material, and
when the thickness of said electrode material mixture layer is designated as T, an amount W₁ of said binder in a region 0.1 T thick from the surface side of said electrode material mixture layer, and an amount W₂ of said binder in a region 0.1 T thick from the current collector side of said electrode material mixture layer, satisfy 0.9≦W₁/W₂≦1.1.

2. The electrode for a non-aqueous electrolyte secondary battery in accordance with claim 1, wherein said electrode active material has an olivine-type crystal structure.

3. The electrode for a non-aqueous electrolyte secondary battery in accordance with claim 2, wherein said electrode active material has a composition represented by the general formula LiₓMe(PO_{y})_{z}, where 0<x≦2, 3≦y≦4, 0.5<z≦1.5, and Me is at least one selected from the group consisting of Na, Mg, Sc, Y, Mn, Fe, Co, Ni, Cu, Zn, Al, Cr, Pb, Sb, and B.

4. The electrode for a non-aqueous electrolyte secondary battery in accordance with claim 3, wherein 20 mol % or more of said Me is Fe.

5. The electrode for a non-aqueous electrolyte secondary battery in accordance with claim 1, wherein said electrode active material contains a lithium titanium oxide having a spinel-type crystal structure.

6. The electrode for a non-aqueous electrolyte secondary battery in accordance with claim 5, wherein said lithium titanium oxide has a composition represented by the general formula LiₓTi_{y-w}M_{w}O_{3-z}, where 0.01≦w≦0.2, 0.8≦x≦1.4, 1≦y≦2, 0≦z≦0.6, and M is at least one selected from the group consisting of Na, Mg, Sc, Y, Mn, Fe, Co, Ni, Cu, Zn, Al, Cr, Pb, Sb, and B.

7. The electrode for a non-aqueous electrolyte secondary battery in accordance with claim 1, wherein said binder includes at least one selected from the group consisting of polytetrafluoroethylene, polyvinylidene fluoride, modified polyvinylidene fluoride, tetrafluoroethylene-hexafluoropropylene copolymer, vinylidene fluoride-hexafluoropropylene copolymer, styrene-butadiene rubber, polyethylene, and polypropylene.

8. A method for producing an electrode for a non-aqueous electrolyte secondary battery, said method comprising the steps of:
preparing an electrode material mixture paste which includes as a solid content, a metal oxide-containing electrode active material and a binder, the concentration of said solid content being 65 to 99 wt %; and
pressing said electrode material mixture paste on a surface of a current collector to form a film, followed by drying, thereby forming an electrode material mixture layer,
wherein the oil absorption capacity of said electrode active material is 25 g or more and 200 g or less, per 100 g of said electrode active material.

9. The method for producing a non-aqueous electrolyte secondary battery in accordance with claim 8, including the step of synthesizing by spray pyrolysis, said metal oxide-containing electrode active material.

10. A non-aqueous electrolyte secondary battery comprising a positive electrode, a negative electrode, a separator therebetween, and a non-aqueous electrolyte, wherein at least one of said positive electrode and said negative electrode is the electrode for a non-aqueous electrolyte secondary battery in accordance with claim 1.
